(19) United States
(12) Patent Application Publication
(10) Pub. No.: US 2013/0275561 A1
(43) Pub. Date: Oct. 17, 2013

(54) ADAPTIVE AND CONFIGURABLE CONTENT DELIVERY AND ROUTING

(71) Applicant: RIMAGE CORPORATION, Minneapolis, MN (US)

(72) Inventors: Eric George Phillips, San Francisco, CA (US); David V. Bukhan, Palo Alto, CA (US); Michael David Poindexter, San Mateo, CA (US); Claude Dupuis, San Francisco, CA (US); Edward Majcher, San Francisco, CA (US)

(73) Assignee: Rimage Corporation, Minneapolis, MN (US)

(21) Appl. No.: 13/862,343

(22) Filed: Apr. 12, 2013

Related U.S. Application Data
(60) Provisional application No. 61/623,671, filed on Apr. 13, 2012.
(60) Provisional application No. 61/643,036, filed on May 4, 2012.

(51) Int. Cl. H04L 29/06

(52) U.S. Cl. CPC H04L 65/60
USPC 709/219

(57) ABSTRACT

An example embodiment includes an enterprise media content system. The enterprise media content system includes a data storage device, a network component, and a video control center. The data storage device is configured to store an enterprise media content transcoded into a bundle of renditions. The network component is configured to receive a content request for the enterprise media content from a device and to communicate a most appropriate rendition of the enterprise media content selected from the bundle of renditions to the device. The video control center is configured to determine the most appropriate rendition based on real-time circumstances of the content request.

### CROSS-REFERENCE TO RELATED APPLICATIONS

This patent application claims the benefit of and priority to U.S. Provisional Application Ser. No. 61/623,671 filed on Apr. 13, 2012 and U.S. Provisional Application Ser. No. 61/643,036 filed on May 4, 2012, which are incorporated herein by reference.

### FIELD

The embodiments discussed herein are related to communicating and managing enterprise media content.

### BACKGROUND

Enterprises such as multi-national corporations or governmental organizations may create various enterprise media content. The enterprise media content may include, but is not limited to, corporate communication content, live webcasts, training videos, audio files, product materials, etc. Users such as employees or clients may want access to the enterprise media content via an internal network operated by the enterprise, the internet, mobile networks, or some combination thereof.

However, by allowing access to the enterprise media content, the enterprise may introduce possible security risks to the enterprise and/or inefficiencies into the enterprise. For example, to provide access via the internal network, the enterprise may purchase a finite amount of network bandwidth. The network bandwidth becomes a resource of the enterprise to conduct various operations as well as to provide access to enterprise media content. When users access enterprise media content, the network bandwidth may be depleted. Additionally, providing access to enterprise media content via the internet and/or mobile networks may introduce security issues. For example, when sensitive enterprise media content is locally saved, the enterprise may lose control of the sensitive enterprise media content.

Moreover, the enterprise media content introduces complexity into the enterprise due to non-standardization. For example, devices associated with or operated by different users may have differing capabilities and/or may connect to the enterprise through unreliable or public networks. Thus, the enterprise may provide access to multiple renditions of the enterprise media content to appease the different users.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

According to an aspect of an embodiment, a system includes an enterprise media content system. The enterprise media content system includes a data storage device, a network component, and a video control center. The data storage device is configured to store an enterprise media content transcoded into a bundle of renditions. The network component is configured to receive a content request for the enterprise media content from a device and to communicate a most appropriate rendition of the enterprise media content selected from the bundle of renditions to the device. The video control center is configured to determine the most appropriate rendition based on real-time circumstances of the content request.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

To further clarify the above and other advantages and features of the present invention, a more particular description will be rendered by reference to specific embodiments thereof which are illustrated in the appended drawings. It is appreciated that these drawings depict only embodiments and are, therefore, not to be considered limiting of its scope. The embodiments will be described and explained with additional specificity and detail through the use of the accompanying drawings in which:

FIG. 1 illustrates a block diagram of an example enterprise media content system in which some embodiments may be implemented;

FIG. 2 illustrates a table of example enterprise media content transcoded into bundles of renditions that may be implemented in the enterprise media content system of FIG. 1;

FIG. 3 is an example network location user interface that may be included in the enterprise media content system of FIG. 1;

FIG. 4 illustrates an example group/client device user interface that may be included in the enterprise media content system of FIG. 1;

FIG. 5 illustrates an example group/client rule user interface that may be included in the enterprise media content system of FIG. 1;

FIG. 6 illustrates an example audience user interface that may be included in the enterprise media content system of FIG. 1;

FIG. 7 illustrates a table including some example information from the enterprise media content system of FIG. 1;

FIG. 8 is a flowchart of an example method of communicating enterprise media content that can be implemented in the enterprise media content system of FIG. 1;

FIG. 9 is a flowchart of an example method of managing enterprise media content that can be implemented in the enterprise media content systems of FIG. 1; and

FIG. 10 is a block diagram of an example computing device arranged for communicating and managing enterprise media content.

### DESCRIPTION OF SOME EXAMPLE EMBODIMENTS

An example embodiment includes an enterprise media content system (EMC system). The EMC system may be configured to optimize bandwidth of an enterprise while efficiently managing enterprise media content. The EMC system may include a data storage device in which multiple renditions of the enterprise media content are stored. The EMC system also includes a video control center (VCC) configured to determine which rendition of an enterprise media content is most appropriate for a device that is requesting the enterprise media content.

The EMC system includes configurable rules. The configurable rules may be included or configured in one or more user interfaces, which allow an administrator to set up one or more factors that control the determination of the most appropriate rendition. The configurable rules enable specific and flexible control of the determination and the factors incorporated therein.

For example, using the configurable rules the VCC may be configured to make a distinction between a smartphone on a Wi-Fi network or the smartphone on a 3G/4G public network. Based on the network (i.e., the Wi-Fi network or the 3G/4G public network), the determination of the most appropriate rendition may be made. Another example may be a personal computer on an employee's desk or the personal computer in a conference room with a large screen for internet protocol television (IPTV) or group viewing. Based on the screen size associated with the personal computer, the determination of the most appropriate rendition may be made.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

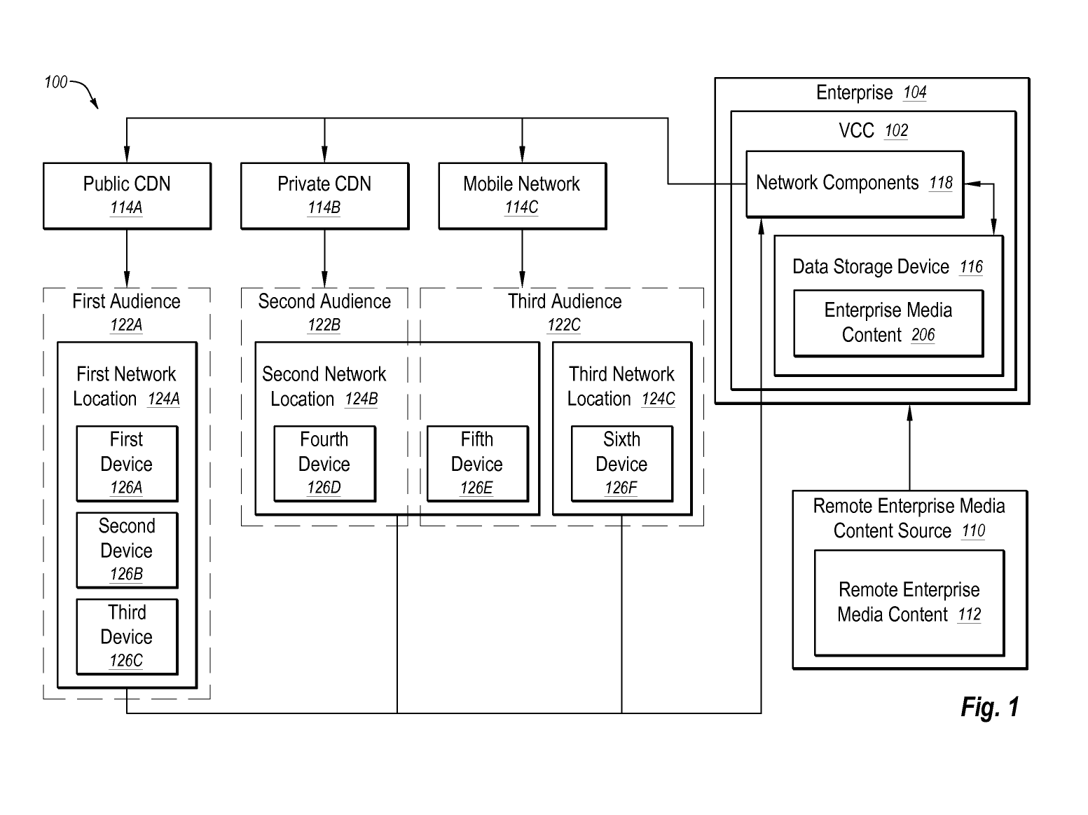

FIG. 1 illustrates a block diagram of an example EMC system 100 in which some embodiments described herein may be implemented. The EMC system 100 may include multiple devices 126A-126F (generally, device or devices 126) and a remote enterprise media content source 110. The devices 126 and the remote enterprise media content source 110 may be in communication with an enterprise 104. The enterprise 104 may include a VCC 102, which may be configured to manage enterprise media content 206 in the enterprise 104. For example, the VCC 102 may be configured to receive the enterprise media content 206, transcode the enterprise media content 206, store enterprise media content 206, communicate the enterprise media content 206 between the devices 126 and the enterprise 104 and/or between the remote enterprise media content source 110 and the enterprise 104, limit bitrate allocation of the enterprise 104, or any combination thereof.

The VCC 102 may be generally configured as a centrally-managed repository for the enterprise media content 206. Accordingly, the VCC 102 may include a data storage device 116, one or more network components 118, and an enterprise media content platform (enterprise platform) (not shown). The VCC 102 may receive enterprise media content 206, which may be created locally or remotely (e.g., at the remote enterprise media content source 110), transcode the received enterprise media content 206 into multiple renditions, store multiple renditions of the enterprise media content 206, and communicate the renditions of the enterprise media content 206 to the devices 126.

The data storage device 116 may include a server or set of servers, for instance, or any other suitable data storage device that may be configured to store the enterprise media content 206. The network components 118 may include encoders, switches, streaming servers, end-to-end network provisioning devices, routers, or some combination thereof. The network components 118 may be configured to receive enterprise media content 206, route or direct the enterprise media content 206 to the data storage device 116, communicate enterprise media content 206 from the VCC 102 to the devices 126, or some combination thereof. As depicted in FIG. 1, the VCC 102 may be located within the enterprise 104. However, this depiction is not meant to be limiting. In alternative embodiments, the VCC 102 or some portion thereof may be located remotely from the enterprise 104.

By centralizing the enterprise media content 206 in the VCC 102, an administrator may control the enterprise media content 206 within the EMC system 100. To perform the controls, the administrator may access the enterprise media content 206 of the VCC 102 via the enterprise platform. Additionally, the enterprise platform may include back end workflows and flexible device-side software development kits for various mobile operating systems, which may be loaded onto one or more of the devices 126. Functions attributed to the enterprise platform may be performed automatically and/or by the administrator using the enterprise platform.

Generally, the enterprise media content 206 may include any media that may be stored and/or disseminated within the EMC system 100. For example, the enterprise media content 206 may include, but is not limited to, real-time webcast material, web objects, posted media files, text web objects, graphics, downloadable media files, software, documents associated with one or more software development kits, enterprise applications, enterprise templates, portals, live streaming media, on-demand streaming media, and social networking applications including real-time conferencing.

Some of the enterprise media content 206 may be characterized as remote enterprise media content 112. The remote enterprise media content 112 may be generated at the remote enterprise media content source 110 and may be communicated to the network components 118 of the VCC 102 via a network/cloud (not shown), such as via an enterprise intranet and/or the internet. The remote enterprise media content source 110 may include a third party enterprise, an employee, a remote division and/or group of the enterprise 104, or any similar entity. The network/cloud may include a collection of devices interconnected by communication channels that enable sharing of information among the interconnected devices. For example, the network/cloud may include any wired or wireless network technology such as optical fiber, electrical cables, Ethernet, radio waves, microwaves, an infrared transmission, wireless network, communication satellites, cloud technologies, cellular telephone signals, or an equivalent networking signal that interfaces with devices to create a network.

Some of the enterprise media content 206 may be characterized as local enterprise media content. The local enterprise media content may include enterprise media content 206 produced locally within the enterprise 104 or enterprise media content 206 that may be communicated to the VCC 102 without interfacing with the network/cloud. Additionally or alternatively, the local enterprise media content may include enterprise media content 206 that may be communicated directly to the data storage device 116 without interfacing with the network components 118 and/or the network/cloud. Once stored on the VCC 102 and/or the data storage device 116, the local enterprise media content and the remote enterprise media content 112 are substantially equivalent.

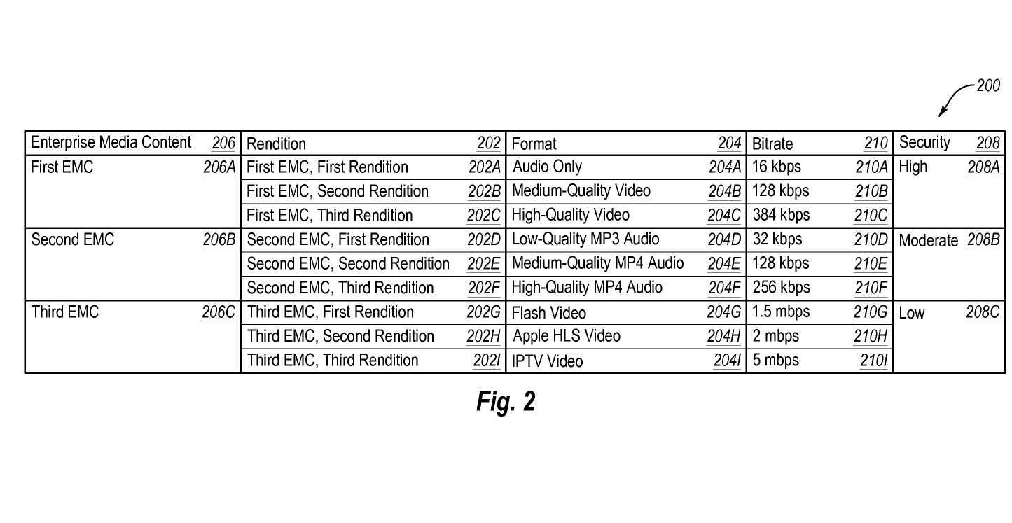

One function of the VCC 102 and/or the enterprise platform may include transcoding the enterprise media content 206 according to a profile to create a bundle of renditions. FIG. 2 illustrates a table 200 of example enterprise media content 206, described above with reference to FIG. 1, transcoded into bundles of renditions. The enterprise media content 206 may enable the VCC and/or the enterprise platform to categorize and/or organize the enterprise media content 206 into a bundle of renditions 202 based on a profile. Each bundle of renditions includes a set of renditions representing the same enterprise media content 206 that may be created from a same source (e.g., the remote enterprise media content source 110).

The profile in table 200 includes a format 204, a bitrate 210, and a security level (in FIG. 2, “security”) 208. The profile in table 200 is not limiting. In some embodiments, other profiles may include any property that describes one or more renditions 202 of the enterprise media content 206.

In the table 200, the enterprise media content 206 includes a first enterprise media content 206A (in FIG. 2, “first EMC 206A”), a second enterprise media content 206B (in FIG. 2, “second EMC 206B”), and a third enterprise media content 206C (in FIG. 2, “third EMC 206C”). In the depicted embodiment, the first enterprise media content 206A may include a recording of a video teleconference with a high security level 208A. An example of the first enterprise media content 206A may include a video recording of an executive meeting. The first enterprise media content 206A may be transcoded into a first EMC, first rendition 202A; a first EMC, second rendition 202B; and a first EMC, third rendition 202C. The first EMC, first rendition 202A may include audio-only MP3 format 204A with a 16 kilobit per second (kbps) bitrate 210A, for example. The first EMC, second rendition 202B may include a medium-quality video format 204B with small dimensions for mobile devices and a 128 kbps bitrate 210B, for example. The first EMC, third rendition 202C may include a high-quality video format 204C with larger dimensions and a 384 kbps bitrate 210C, for example. The first EMC, first rendition 202A; the first EMC, second rendition 202B; and the first EMC, third rendition 202C are one example of a bundle of renditions for the first enterprise media content 206A.

Likewise, the second enterprise media content 206B and the third enterprise media content 206C may be transcoded into bundles of renditions (i.e., 202D-202F and 202G-202I, respectively). Various non-limiting examples for the second enterprise media content 206B and the third enterprise media content 206C include the following. Specifically, the second enterprise media content 206B may include an audio recording such as an audio recording of an inter-enterprise directive. The second enterprise media content 206B may include a moderate security level 208B. The second enterprise media content 206B may be transcoded into a second EMC, first rendition 202D; a second EMC, second rendition 202E; and a second EMC, third rendition 202F. The second EMC, first rendition 202D may include a low-quality MP3 format 204D with a 32 kbps bitrate 210D. The second EMC, second rendition 202E may include a medium-quality MP4 format 204E with a 128 kbps bitrate 210E. The second EMC, third rendition 202F may include a high-quality MP4 format 204F with a 256 kbps bitrate 210F.

The third enterprise media content 206C may include a video file such as a video of an advertisement. The third enterprise media content 206C may include a low security level 208C. The third enterprise media content 206C may be transcoded into a third EMC, first rendition 202G; a third EMC, second rendition 202H; and a third EMC, third rendition 202I. The third EMC, first rendition 202G may include a Flash FLV format 204G and a 1.5 megabit per second (mbps) bitrate 210G. The third EMC, second rendition 202H may include an Apple HLS format 204H and a 2 mbps bitrate 210H, which may be suited for tablet personal computers, for instance. The third EMC, third rendition 202I may include an internet protocol television (IPTV) format 2041 (e.g., MP4 1080i) and a 5 mbps bitrate 210I. With combined reference to FIGS. 1 and 2, a function of the VCC 102 and/or the enterprise platform may include communication of the enterprise media content 206 to the devices 126. To communicate the enterprise media content 206 to the devices 126, a user (not shown) associated with one of the devices 126 may communicate a content request to the VCC 102. The VCC 102 receives the content request and determines a most appropriate rendition of the enterprise media content 206 to communicate to the device 126. The most appropriate rendition generally refers to the rendition 202 of the requested enterprise media content 206 that is best suited for the real-time circumstances of the content request. For example, the most appropriate rendition may include a particular rendition of a bundle of renditions that satisfies more selection criteria than other renditions in the bundle of renditions. The properties of the profile (e.g., format 204, bitrate 210, and security level 208) may be used to characterize the renditions 202 such that the most appropriate rendition, once determined, may be selected from the bundle of renditions of the requested enterprise media content 206.

Referring back to FIG. 1, when the VCC 102 receives a content request, the VCC 102 and/or the enterprise platform may determine the most appropriate rendition. The determination of the most appropriate rendition may be based on real-time circumstances of a content request. Which of the real-time circumstances are dispositive in the determination is controlled by the administrator via configurable rules included in the VCC 102.

The VCC 102 and/or the enterprise platform receive the content request and extract information included therein that indicates the real-time circumstances of the content request. The VCC 102 and/or the enterprise platform may then determine the most appropriate rendition and select the most appropriate rendition from a bundle of renditions. The VCC 102 may then communicate the most appropriate rendition through delivery systems 114A-114C (generally, delivery system 114) to the device 126.

The real-time circumstances may include, but are not limited to, network locations 124A-124C (generally, network location or network locations 124), the delivery system 114, audiences 122A-122C (generally, audience or audiences 122), a device 126 communicating the content request, a device type of the device 126, a defined device group, a user of the device 126, some combination thereof, or some other factor as discussed below.

In addition to determining the most appropriate rendition, the enterprise platform and/or the VCC 102 may set and enforce one or more bitrate caps. The bitrate caps generally relate to the speed at which a rendition may be communicated to a device 126, the size of the rendition, and/or the portion of a total bandwidth of the enterprise 104 the communication of the rendition may consume. Determining the most appropriate rendition and setting the bitrate cap may be related. For example, there is no reason to communicate a rendition requiring a bitrate higher than a device 126 can support. As used herein, the bitrate cap may include a predefined level or some portion of a total bandwidth of the enterprise 104.

In some embodiments, setting the bitrate cap may be performed by the enterprise platform and/or the VCC 102 based on real-time circumstances at the time of a content request. Additionally, the bitrate caps may be applied dynamically at the time of the content request, may be set to a predefined level to allow for smooth streaming of enterprise media content 206, may be set to predefined levels to enable an even or substantially even distribution between two or more users and/or two or more devices, or any combination thereof. For example, the bitrate cap may be set to predefined levels according to real-time loads on the total bandwidth of the enterprise 104. Additionally or alternatively, the bitrate caps may be altered during communication of a rendition by an off-the-shelf streaming application or altered as bandwidth loads changes during communication.

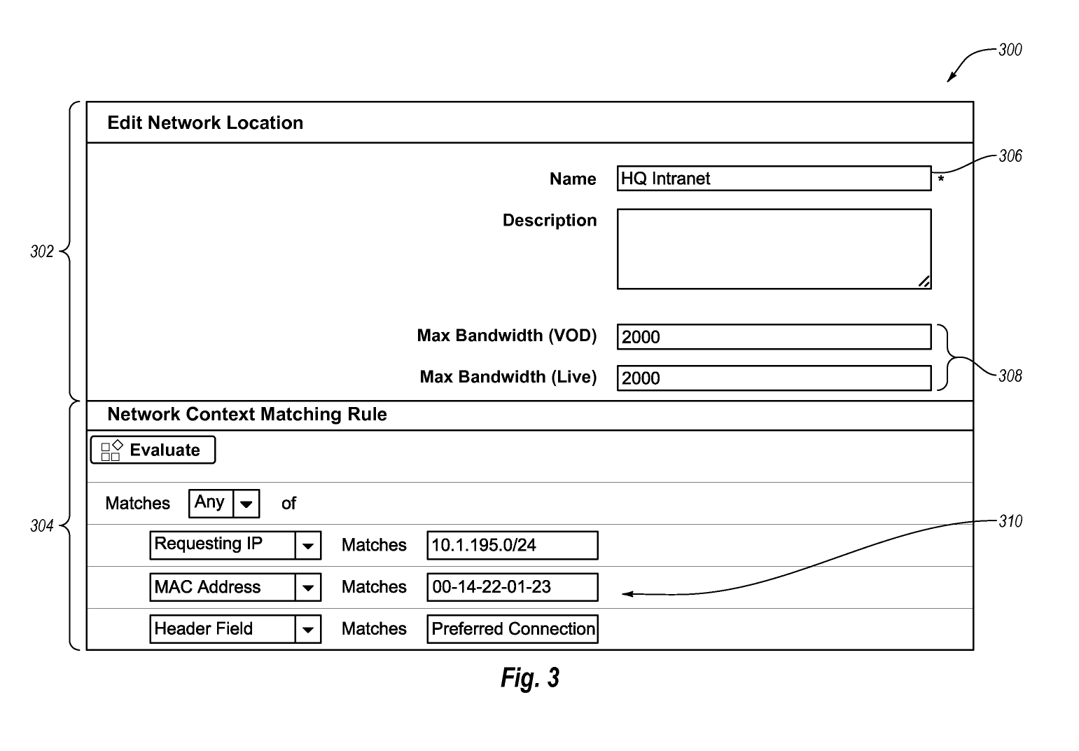

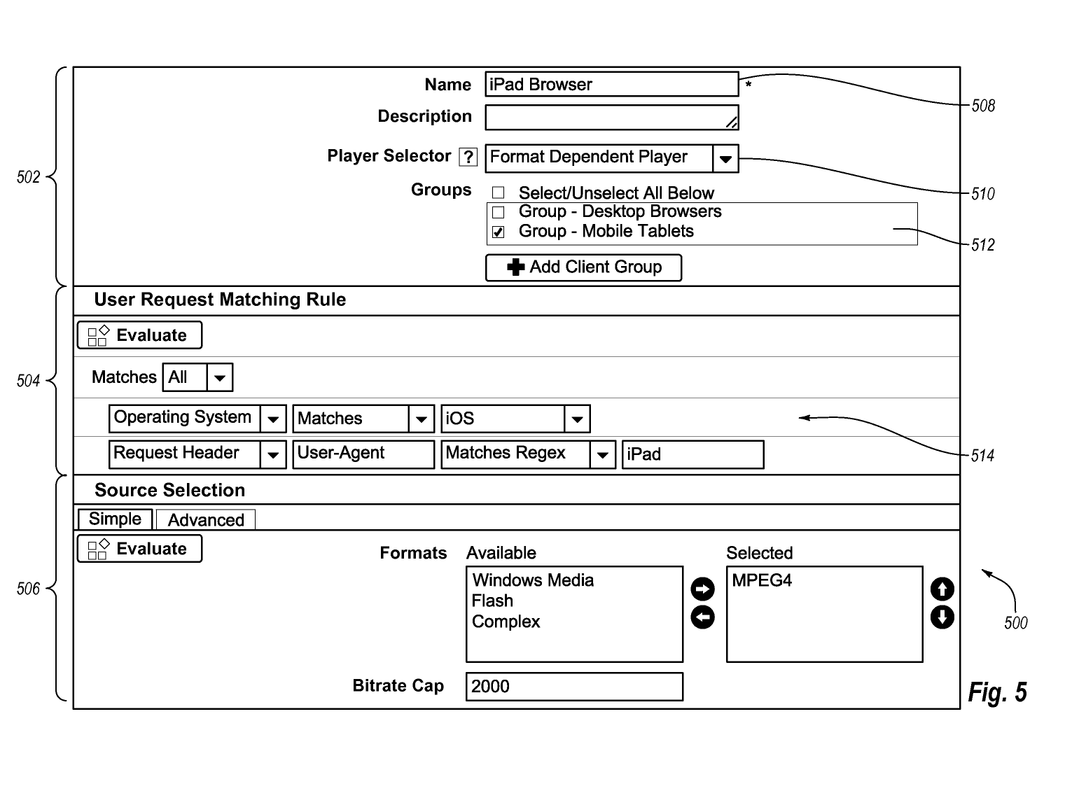

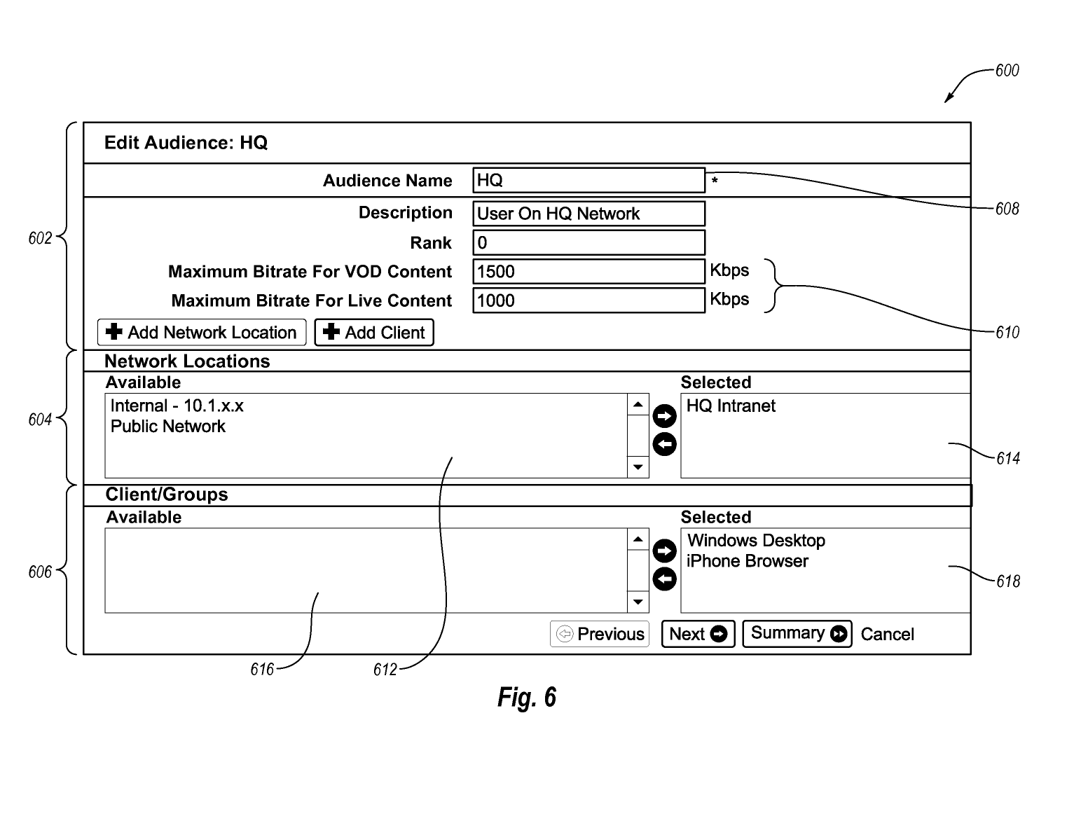

To configure and classify the network locations 124, the delivery system 114, the audiences 122, the devices 126, and to determine the most appropriate rendition and bitrate caps based thereon, the enterprise platform may include one or more configurable rule-based engines. The configurable rule-based engines may include, but are not limited to, a network location rule engine (discussed with reference to FIG. 3), a group/client rule engine (discussed with respect to FIG. 5), and an audience rule engine (discussed with reference to FIG. 6). Using the configurable rule-based engines, factors used in the determination of the most appropriate rendition of the enterprise media content 206 may be controlled, configured, and changed.

FIG. 3 is an example network location user interface (network UI) 300 that may be included in the EMC system 100 of FIG. 1. The network UI 300 is generally related to the network locations 124 of FIG. 1. With combined reference to FIGS. 1 and 3, the network UI 300 may be included in the enterprise platform. The network UI 300 may be operated by the administrator, for example, to define network locations 124, evaluate/detect network locations 124, set bitrate caps for the network locations 124, or any combination thereof.

In FIG. 1, the EMC system 100 is depicted with three network locations 124. The network locations 124 may relate to the physical location of one or more of the devices 126 and/or relate to a type of communication between the devices 126 in the network location 124 and the VCC 102. For example, a first device 126A, a second device 126B, and a third device 126C may be included in a first network location 124A because the first device 126A, the second device 126B, and the third device 126C are physically located at the same location (e.g., the same office). Alternatively, the first device 126A, the second device 126B, and the third device 126C may be included in the first network location 124A because the first device 126A, the second device 126B, and the third device 126C communicate with the VCC 102 using the same type of communication (e.g., via Wi-Fi, 3G, etc.).

The enterprise platform of the VCC 102 may enter and/or record which of the devices 126 are within each of the network locations 124 and/or may be configured to detect which device 126 is within each of the network locations 124. Specifically, based on the content request sent from a device 126, the VCC 102 may detect in which network location 124 the device 126 is located. For example, if a fourth device 126D and a fifth device 126E are personal computers, for instance, and are physically located at an office of the enterprise 104, then the enterprise platform may simply record that information. However, a sixth device 126F may be a mobile telephone. Accordingly, the sixth device 126F may leave the third network location 124C and enter another network location 124. The enterprise platform may be configured to detect from which of the network locations 124 the sixth device 126F is communicating at the time of the content request.

A top portion 302 included in the network UI 300 may enable the administrator to enter information related to one or more of the network locations 124. For example, a network location 124 named “HQ intranet” is identified in a name field 306 of the network UI 300. Additionally, bitrate caps may be set in maximum bandwidth fields 308. In the depicted embodiment, there are two bitrate caps, one each in the maximum bandwidth fields 308. One of the bitrate caps is for video on demand (VOD) and another of the bitrate caps is for live media (live). Both the VOD bitrate cap and the live bitrate cap are set to a predefined level of 2000 kbps in the example of FIG. 3.

A bottom portion 304 may include a network location rule engine that is an example of a configurable rule-based engine discussed above. In the bottom portion 304 included in the network UI 300, the administrator may construct a rule-based procedure to evaluate and/or detect the network location 124 of the device 126 communicating a content request. In this and other embodiments, the bottom portion 304 includes a rule-based evaluation field 310. The rule-based evaluation field 310 of FIG. 3 includes an internet protocol (IP) address, a MAC address, and a header field. When the IP address, the MAC address, or the header field included in the rule-based evaluation field 310 is detected in the content request, the IP address, the MAC address, or the header field may indicate that the device 126 is in the network location 124 specified in the name field 306 of the top portion 302.

More specifically, in the depicted example, if the enterprise platform detects a content request originated at one of the IP addresses, the MAC address, and the header field listed in the rule-based evaluation field 310, the enterprise platform may determine that the content request originated at a device 126 in the network location 124 named “HQ intranet.” Accordingly, the enterprise platform may retrieve the predefined level of “2000 kbps” from the maximum bandwidth fields 308 and may limit communication of enterprise media content 206 to the device 126 to the predefined level of 2000 kbps.

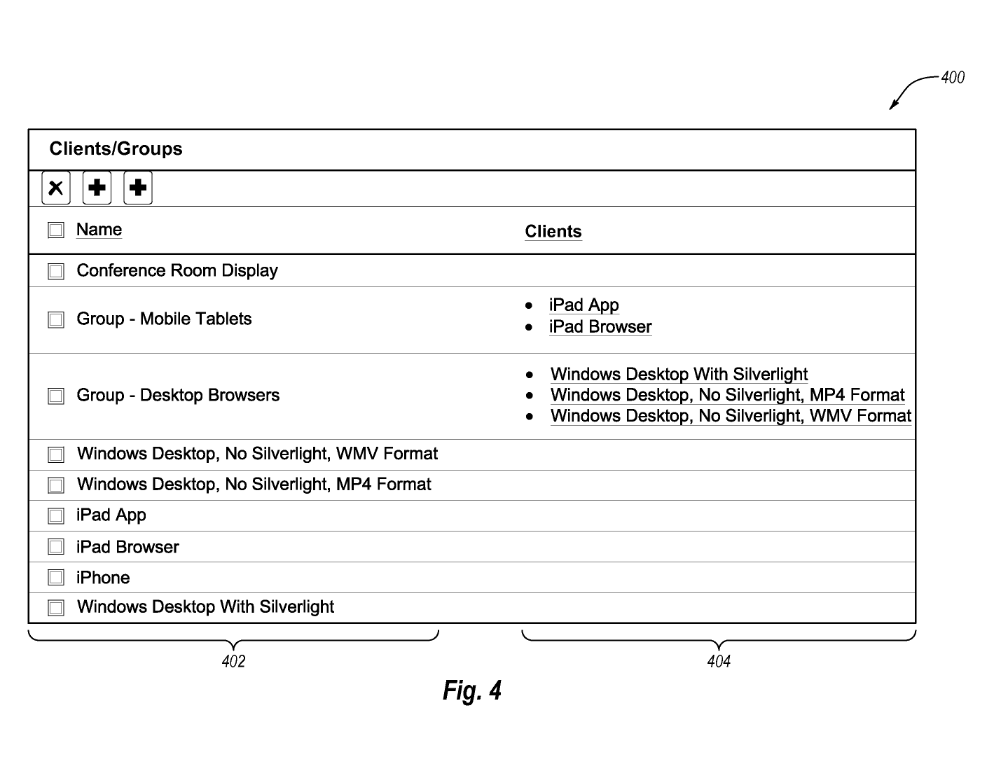

FIG. 4 illustrates an example group/client device user interface (group/client device UI) 400 that may be included in the EMC system 100 of FIG. 1. FIG. 5 illustrates an example group/client rule user interface (group/client rule UI) 500 that may be included in the EMC system 100 of FIG. 1. The group/client rule UI 500 is an example of a configurable rule-based engine discussed above. The group/client device UI 400 and the group/client rule UI 500 are collectively referred to herein as group/client UIs 400 and 500. The group/client UIs 400 and 500 generally relate to or enable the grouping of the devices 126 of FIG. 1. The group/client UIs 400 and 500 may define device groups 402, evaluate and detect device types, evaluate and detect device characteristics, cap bitrates for the devices 126 and/or the device groups 402, or some combination thereof.

With combined reference to FIGS. 1, 4, and 5, the enterprise platform of the VCC 102 may organize and/or classify the devices 126 based on information related to the devices 126. For example, the enterprise platform may organize and/or classify the devices 126 based on one or more device characteristics, a device type, a user associated with the device, or some combination thereof. The information related to the devices 126 may be entered into the VCC 102 by the administrator to define one or more device groups 402. The device groups 402 may range in “customization.” For example, a first device group may include all desktop computers operating with a specific web development tool while a second device group may include a single device operated by a specific user, such as the mobile tablet computer of a CEO of the enterprise 104.

In some embodiments, a device group 402 may be defined according to a user associated with a device 126. The term “associated,” as used to describe the relationship between the user and the device 126, generally means that the user may operate the device 126, has control, at least temporarily, of the device 126, and when a content request is sent from the device 126, the VCC 102 and/or the enterprise 104 assume or may detect that the content request originated with the user. The association can be established by the user signing in to the VCC 102 with a credential or credentials assigned to the user. Alternatively, the device 126 can send device identification information to the VCC 102. The VCC 102 can receive the device identification information and maintain mapping between the device identification information and the user. An example device group 402 based on the user may include a personal computer of the CEO of the enterprise 104.

In some embodiments, a device group 402 may be defined according to device type. Generally, the device type may include, but is not limited to, a mobile phone, a smartphone, a personal digital assistant, a laptop computer, a personal computer, a monitor with networking capabilities, a television with networking capabilities, a tablet computer, or another network communication device. An example device group 402 based on device type may include all of the devices 126 that are mobile tablet computers. In these and other embodiments, the enterprise platform may also support preconfigured device types. For example, the preconfigured device types may be configured for common devices 126 (e.g., common personal computers or common smartphones) and/or devices 126 that may be issued by the enterprise 104.

In some embodiments, a device group 402 may be based on one or more device characteristics. Some example device characteristics may include an operating system, a browser type, one or more parameters sent by the device 126 such as HTTP headers or query string parameters, or some combination thereof. An example device group 402 based on device characteristic may include all of the devices 126 running a particular operating system.

In some embodiments, a device group 402 may be based on other information pertaining to one or more devices 126. For example, a device group 402 may be defined according to a location, an identified use, a specific project, etc. An example device group 402 based on other information pertaining to a device 126 may include a device group 402 defined to include a personal computer located in a conference room of the enterprise 104.

By defining the device groups 402, the enterprise platform may deal with the devices 126 and/or content requests sent from the devices 126 in the device group 402 similarly. For example, the enterprise platform may determine that a same rendition of the enterprise media content 206 is the most appropriate for the devices 126 in the device group 402. Additionally, the enterprise platform may determine that the devices 126 in the device group 402 may communicate to the enterprise media content 206 at a same bitrate.

The group/client device UI 400 may be configured to present the device groups 402. Some of the device groups 402 include one or more clients 404, which may also be presented in the group/client device UI 400. The clients 404 are generally sub-device groups or device groups 402 included in larger device groups 402. For example, in FIG. 4, an “iPad App” and an “iPad Browser” are included as the clients 404 in a device group 402 named “Group-Mobile Tablets.” However, “iPad App” and “iPad Browser” are also device groups 402. As depicted in FIG. 4, the device group 402 “Group-Mobile Tablets” includes devices 126 included in the device groups 402 “iPad App” and “iPad Browser.”

The group/client rule UI 500 may include a top portion 502 that enables the administrator to define the device groups 402 and/or to create group-client relationships via a player selector field 510 and a group field 512. For example, the top portion 502 may include a name field 508 that corresponds to a name of a client 404 in FIG. 4. In the depicted example, the name of the client 404 is “iPad Browser.” The administrator may create a group-client relationship by selecting “format dependent player” in the player selector field 510. The administrator may select a device group 402 in the group field 512 in which to include the client 404.

The group/client rule UI 500 may also include a rule-based engine 504 that enables the administrator to build a set of rules to evaluate or detect the device 126 communicating the content request and a device group 402 to which the device 126 belongs. In this and other embodiments, the rule-based engine 504 includes a rule-based matching field 514. The rule-based matching field 514 includes one or more criteria to be met such as a specific operating system and a request header, which indicates a device group 402 of the device 126. If the criteria are detected in the content request, then the enterprise platform may recognize that the device 126 is a specific type of device 126 and/or that the device 126 includes certain device characteristics.

In a lower portion of the group/client rule UI 500 is a result portion 506 related to the rule-based engine 504. The result portion 506 may allow the administrator to select a rendition of the requested enterprise media content 206 to communicate to the device 126 and/or to cap the bitrate based on the criteria set in the rule-based engine 504. For example, in the depicted embodiment, when the content request indicates that the device 126 has an operating system equal to iOS and the content request includes a requesting header indicating that the requesting device is an iPad, the VCC 102 may communicate a rendition formatted as an MPEG4 at a maximum bitrate of 2000 kbps.

Referring back to FIG. 1, the EMC system 100 may include one or more audiences 122. The audiences 122 may include a variable subset of the users or the devices 126 defined according to a set of attributes shared at the time the content request is received. Example attributes may include, but are not limited to, a characteristic of the users, a device 126 associated with the user, a device type of the device 126, a device characteristic such as the ability to support a format of enterprise media content, a network location 124 of the user or the device 126, a device group (402 in FIG. 4), or some combination thereof.

When a content request is received, the enterprise platform evaluates the real-time circumstances to determine which attributes the device 126 communicating the content request has. The enterprise platform determines in which of the audiences 122 the device 126 is included. The most appropriate rendition may be selected based on the audience 122 of the device 126. Additionally, bitrate caps may be set for the audiences 122. The most appropriate rendition of the enterprise media content 206 may be based on a bitrate cap defined for the audiences 122.

The audiences 122 may be broad, including multiple devices 126, or may be individualized to a user or a specific device. Additionally, because the attributes may include a device group and/or a network location 124, there is flexibility in defining the audiences 122. Additionally, the users and/or the devices 126 included at any time in one of the audiences 122 may vary based on the real-time circumstances at the time of the content request.

In some embodiments, one of the delivery systems 114 may be mapped to each of the audiences 122 by the enterprise platform of the VCC 102. For example, in FIG. 1, the first audience 122A is mapped to a public content delivery network (CDN) 114A, the second audience 122B is mapped to a private CDN 114B, and the third audience 122C is mapped to a mobile network 114C. Generally, a CDN such as the public CDN 114A or the private CDN 114B delivers media content to the users of the devices 126. CDNs may include a system of servers that may be located in one or more physical locations. The public CDN 114A may include servers owned or operated by or rented by a third party CDN provider that delivers media content for pay. The private CDN 114B may include servers owned or operated by or rented by the enterprise 104 to deliver the enterprise media content 206 to the devices 126. Other examples of the delivery system 114 may include an enterprise intranet, 3G/4G/LTE wireless networks, and the like or any combination thereof.

FIG. 6 is an example audience user interface (audience UI) 600 that may be included in the EMC system 100 of FIG. 1. With combined reference to FIGS. 1 and 6, the audience UI 600 may be included in the enterprise platform. The audience UI 600 may be operated by the administrator, for example, to define the audiences 122 according to one or more attributes, evaluate/detect attributes of a content request indicating an audience 122, set bitrate caps for one or more of the audiences 122, or some combination thereof.

The audience UI 600 may include an audience-defining portion 602. The audience-defining portion 602 may include an audience name field 608 and a bitrate-limiting field 610. The bitrate-limiting field 610 may include one or more maximum bitrates (i.e., bitrate caps) that may depend on the type of enterprise media content, for instance. By entering values into the audience name field 608 and/or the bitrate-limiting field 610, the administrator may define an audience 122 and/or set a bitrate cap for the audience 122. For example, in FIG. 6, an “HQ” audience 122 has a bitrate cap of 1500 kbps for VOD content and a bitrate cap for live content of 1000 kbps in the bitrate-limiting field 610.

A network location inclusion field 604 and a client/group inclusion field 606 may also be included in the audience UI 600. The network location inclusion field 604 may enable the administrator to define an audience to include one or more network locations 124. For example, the network location inclusion field 604 in FIG. 6 includes an available network location field 612 and a selected network location field 614. The administrator may view available network locations 124 in the available network location field 612. The administrator may select all or a subset of the network locations 124 in the available network location field 612, thereby placing the selected network locations 124 into the selected network location field 614. By doing so, the administrator may include the selected network locations 124 in the audience 122.

With combined reference to FIGS. 1, 3, and 6, in some embodiments, the audience UI 600 may interface with the network UI 300 of FIG. 3 to detect in which network location 124 the user or the device 126 is located at the time of the content request. For example, the enterprise platform may detect an IP address indicating a network location 124. The enterprise platform of the VCC 102 may detect the network location 124 and determine a corresponding audience 122. The enterprise platform may then select a most appropriate rendition for the audience 122 and/or the network location 124. Additionally, the enterprise platform may apply the bitrate cap imposed on the audience 122 and/or the network location 124.

Likewise, with combined reference to FIGS. 1, 4, and 6, the client/group inclusion field 606 may enable the administrator to include one or more device groups 402 and/or clients 404 in an audience 122. For example, the client/group inclusion field 606 in FIG. 6 includes an available client/group field 616 and a selected client/group field 618. The administrator may view available device groups 402 and/or clients 404 in the available client/group field 616. The administrator may select a subset of the device groups 402 and/or clients 404 in the available network location field 612, which may place the selected device groups 402 and/or clients 404 into the selected network location field 614. By doing so, the administrator may define an audience 122 to include the selected device groups 402 and/or the selected clients 404.

In some embodiments, the audience UI 600 may interface with the group/client rule UI 500 of FIG. 5 to detect in which device group 402 or client 404 the user or the device 126 is included at the time of the content request. For example, the enterprise platform may detect a device type, a device characteristic, device identification information, credentials assigned to a user, or other information pertaining to a device 126. The enterprise platform may detect the device group 402 and/or client 404 and determine a corresponding audience 122. Based on the detected device group 402, client 404, and the audience 122, the VCC 102 may select a most appropriate rendition and/or apply a bitrate cap imposed on the audience 122 and/or the device group 402.

In some embodiments, the audience UI 600 may interface with the group/client rule UI 500 of FIG. 5 and the network UI 300 of FIG. 3 at the time the content request is made. In this and other embodiments, the enterprise platform may detect the network location 124, the device group 402 or client 404, and determine a corresponding audience 122. Based on the network location 124, the device group 402 or client 404, and audience 122, the enterprise platform may select a most appropriate rendition of the enterprise media content, select a delivery system 114, enforce a bitrate cap, or some combination thereof.

In some embodiments, the audience UI 600 may be configured to publish the enterprise media content 206 to a target audience. The target audience may be selected and the enterprise media content 206 may be pushed to the target audience. Choosing the target audience may be based upon the nature of the enterprise media content 206, a specific message in the enterprise media content 206, an attribute of the audience 122, etc.

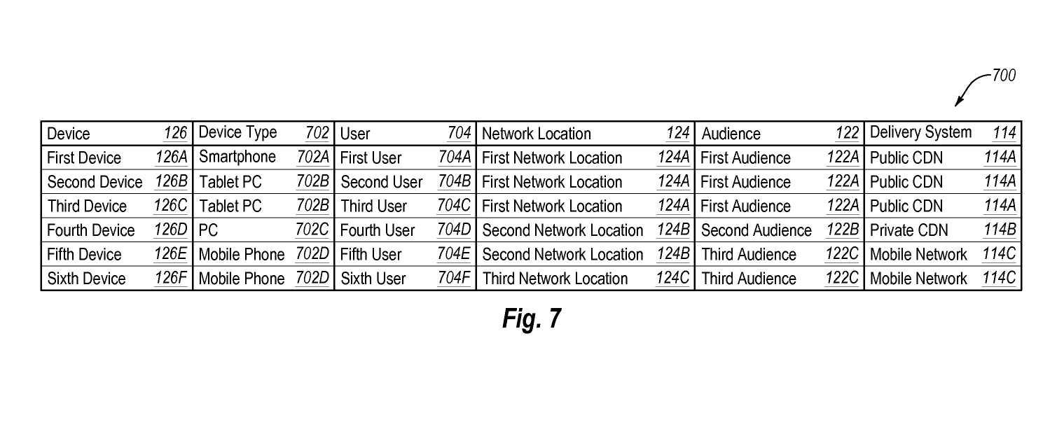

FIG. 7 is a table 700 including an example subset of information from the EMC system 100 of FIG. 1. Additionally, in the table 700, a device type 702 and a user 704 are included. With combined reference to FIGS. 1, 2, and 7, some example determinations for the most appropriate rendition of the enterprise media content 206 are provided. In each example, the enterprise 104 may seek to optimize the bandwidth of an enterprise network.

A first example is provided for a specific user. A fourth user 704D may be a CEO, for instance, and may be presenting the first enterprise media content 206A at an office of the enterprise 104. Accordingly, a second audience 122B may be defined to include the fourth user 704D. Additionally, the administrator may set the bitrate cap at greater than 384 kbps for the second audience 122B, thereby allowing the third media rendition 202C to be used. When the fourth user 704D communicates a content request from the PC 702C for the first enterprise media content 206A, the content request may be routed to the first EMC, third rendition 202C. The bandwidth of the enterprise network may be properly allocated to ensure the first EMC, third rendition 202C may be supported.

A second example may include the fifth device 126E and the sixth device 126F, which may be associated with a fifth user 704E and a sixth user 704F, respectively. In this example, the fifth user 704E and the sixth user 704F are traveling salespeople. Both of the fifth device 126E and the sixth device 126F are mobile phones 702D. The VCC 102 may map a third audience 122C with a delivery system 114 that includes a mobile network 114C and set a bitrate cap of 64 bits per second (bits/s). When the fifth user 704E or the sixth user 704F communicates a content request from a mobile phone 702D for the second enterprise media content 206B, the content request may be routed to the second EMC, first rendition 202D. The bandwidth of the enterprise network may be properly allocated to ensure the second EMC, first rendition 202D may be supported.

A third example may include a first user 704A, a second user 704B, and a third user 704C which may be associated with the first device 126A, the second device 126B, and the third device 126C, respectively. The first user 704A, the second user 704B, and the third user 704C may be included in the first audience 122A which may be mapped to a public CDN 114A. The first device 126A may be a smartphone 702A, and the second and third devices 126B and 126C may be tablet PCs 702B. The enterprise platform may determine that the most appropriate rendition for the first user 704A may differ from the most appropriate rendition for the second and third users 704B and 704C as a result of the difference in device type 702. Thus, when the first user 704A communicates a content request from the smartphone 702A for the third enterprise media content 206C, the content request may be routed to the third EMC, first rendition 202G. However, when the second user 704B or the third user 704C communicates a content request from the tablet PCs 702B for the third enterprise media content 206C, the content request may be routed to the third EMC, second rendition 202H.

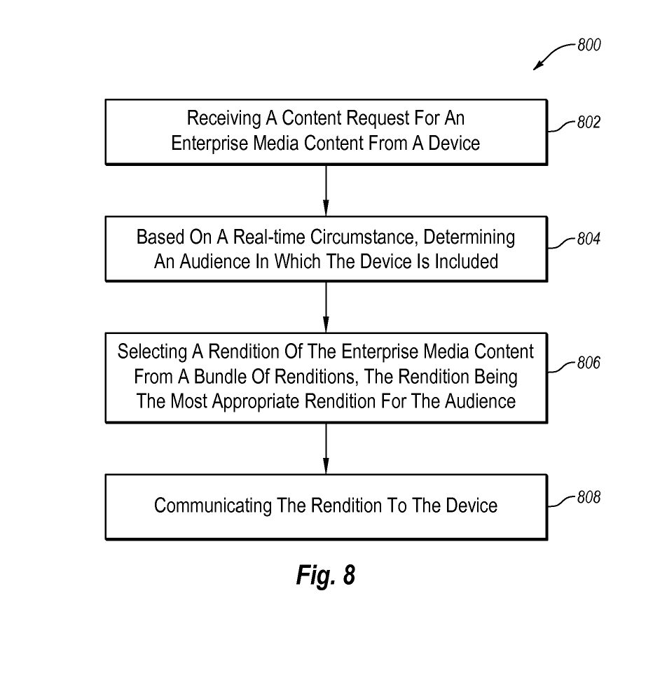

FIG. 8 illustrates a flowchart of an example method 800 of communicating enterprise media content. In some embodiments, the method 800 may be performed by the enterprise platform or the VCC 102, for instance. Although illustrated as discrete blocks, various blocks may be divided into additional blocks, combined into fewer blocks, or eliminated, depending on the desired implementation.

The method 800 may begin at 802 by receiving a content request for an enterprise media content from a device. Based on a real-time circumstance, at 804, the method 800 may include determining an audience in which the device is included. The audience may be defined to include one or more device groups and/or one or more network locations. The network locations may be further defined according to a physical location and/or a type of communication. Likewise, the device groups may be further defined according to one or more of a device type, a location of the device, a device characteristic, and a user associated with the device.

In some embodiments, determining the audience may include detecting a device group in which the device is included at the time the content request is received, detecting the device type, the location of the device, the device characteristic, and the user associated with a device at the time the content request is received, detecting a network location in which the device is included at the time the content request is received, detecting the physical location of the device and/or the type of communication used to communicate the content request, or any combination thereof.

At 806, the method 800 may include selecting a rendition of the enterprise media content from a bundle of renditions. The rendition selected may be the most appropriate rendition for the audience. At 808, the method 800 may include communicating the rendition to the device.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For instance, the method 800 may include determining a bitrate cap at which the rendition is communicated to the device and capping the bitrate at which the rendition is communicated to the device. Determining the bitrate cap may occur at the time the content request is received.

In some embodiments in which the audience is defined to include a device group and a network location, a first bitrate cap for the network location, a second bitrate cap for the device group, and a third bitrate cap for the audience may each be determined at the time the content request is received. In these embodiments, the rendition may be communicated to the device at a lowest of the first bitrate cap, the second bitrate cap, and the third bitrate cap.

Alternatively, in some embodiments, capping the bitrate may include providing a substantially even distribution of bandwidth between the device and a second device to which another rendition is being communicated.

Additionally in some embodiments, the device may be associated with a user. In these and other embodiments, the method 800 may include receiving device identification information or a credential assigned to the user. Based on the credential or the device identification information, a rendition of the enterprise media content may be selected from the bundle of renditions. The rendition may be the most appropriate rendition for the user.

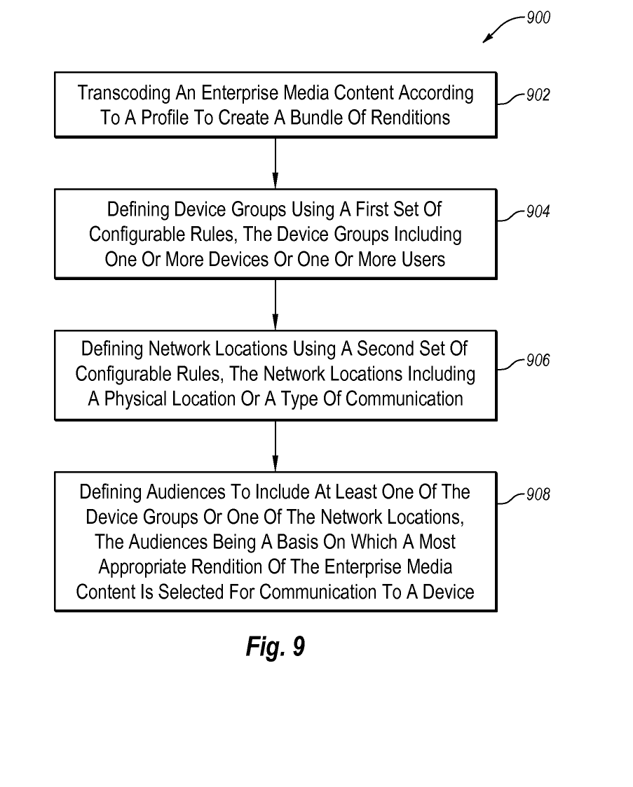

FIG. 9 is a flowchart of an example method 900 of managing enterprise media content. In some embodiments, the method 900 may be performed by the enterprise platform or the VCC 102, for instance. Although illustrated as discrete blocks, various blocks may be divided into additional blocks, combined into fewer blocks, or eliminated, depending on the desired implementation.

The method 900 may begin at 902 by transcoding an enterprise media content according to a profile to create a bundle of renditions. The profile may include one or more of a format, bitrate, security, etc.

At 904, the method 900 may include defining device groups using a first set of configurable rules, the device groups including one or more devices or one or more users. In some embodiments, the device groups are defined according to one or more of a device type, a location of a device, a device characteristic, and a user associated with a device.

At 906, the method 900 may include defining network locations using a second set of configurable rules. The network locations may include a physical location or a type of communication between one or more devices included in a network location.

At 908, the method 900 may include defining audiences to include at least one of the device groups or one of the network locations. The audiences may be a basis on which a most appropriate rendition of the enterprise media content is selected for communication to a requesting device.

In some embodiments, a bitrate at which the most appropriate rendition is communicated to the audiences may be capped. Additionally or alternatively, a bitrate at which the rendition is communicated to one or more of the device groups and/or to one or more of the network locations may be capped.

In some embodiments, a delivery system may be mapped to one or more of the audiences. In these and other embodiments in which a delivery system is mapped to one or more of the audiences, the most appropriate rendition is communicated to a device via the delivery system.

Additionally or alternatively, a target audience may be defined. The target audience may include one or more of the audiences previously defined. In these and other embodiments, the method 900 may include pushing a rendition of the bundle of renditions to the target audience.

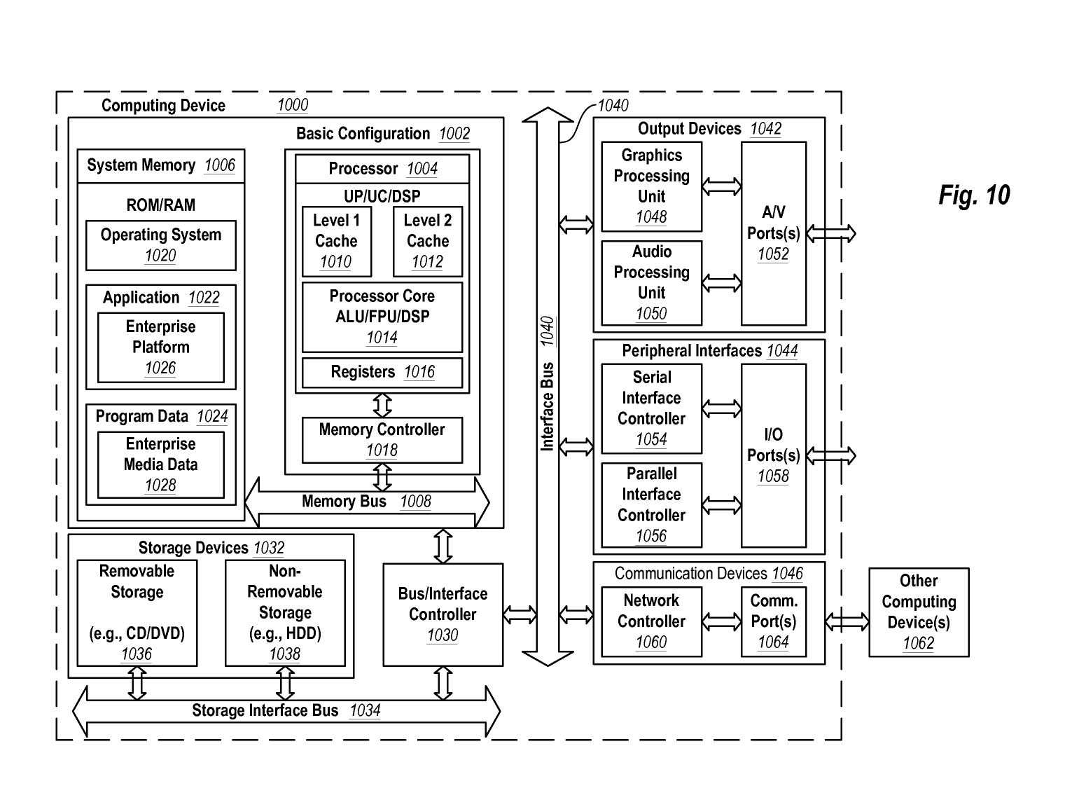

FIG. 10 illustrates a block diagram illustrating an example computing device 1000 that is arranged for communicating and managing enterprise media content in accordance with at least one embodiment of the present disclosure. In a basic configuration 1002, computing device 1000 typically includes one or more processors 1004 and a system memory 1006. A memory bus 1008 may be used for communicating between processor 1004 and system memory 1006.

Depending on the desired configuration, processor 1004 may be of any type including, but not limited to, a microprocessor (μP), a microcontroller (μC), a digital signal processor (DSP), or any combination thereof. Processor 1004 may include one or more levels of caching, such as a level one cache 1010 and a level two cache 1012, a processor core 1014, and registers 1016. An example processor core 1014 may include an arithmetic logic unit (ALU), a floating point unit (FPU), a digital signal processing core (DSP Core), or any combination thereof. An example memory controller 1018 may also be used with processor 1004, or in some implementations memory controller 1018 may be an internal part of processor 1004.

Depending on the desired configuration, system memory 1006 may be of any type including, but not limited to, volatile memory (such as RAM), nonvolatile memory (such as ROM, flash memory, etc.) or any combination thereof. System memory 1006 may include an operating system 1020, one or more applications 1022, and program data 1024. Application 1022 may include an enterprise platform 1026 that is arranged to determine a most appropriate rendition of enterprise media content as described herein. Program data 1024 may include enterprise media data 1028 such as renditions of the enterprise media content and/or bitrate cap that may be useful for communicating enterprise media content as is described herein. In some embodiments, application 1022 may be arranged to operate with program data 1024 on operating system 1020 such that communicating enterprise media content may be performed on the computing device 1000.

Computing device 1000 may have additional features or functionality, and additional interfaces to facilitate communications between basic configuration 1002 and any required devices and interfaces. For example, a bus/interface controller 1030 may be used to facilitate communications between basic configuration 1002 and one or more data storage devices 1032 via a storage interface bus 1034. Data storage devices 1032 may be removable storage devices 1036, non-removable storage devices 1038, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer-readable instructions, data structures, program modules, or other data.

System memory 1006, removable storage devices 1036, and non-removable storage devices 1038 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1000. Any such computer storage media may be part of computing device 1000.

Computing device 1000 may also include an interface bus 1040 for facilitating communication from various interface devices (e.g., output devices 1042, peripheral interfaces 1044, and communication devices 1046) to basic configuration 1002 via bus/interface controller 1030. Example output devices 1042 include a graphics processing unit 1048 and an audio processing unit 1050, which may be configured to communicate to various external devices such as a display or speakers via one or more A/V ports 1052. Example peripheral interfaces 1044 include a serial interface controller 1054 or a parallel interface controller 1056, which may be configured to communicate with external devices such as input devices (e.g., keyboard, mouse, pen, voice input device, touch input device, etc.) or other peripheral devices (e.g., printer, scanner, etc.) via one or more I/O ports 1058. An example communication device 1046 includes a network controller 1060, which may be arranged to facilitate communications with one or more other computing devices 1062 over a network communication link via one or more communication ports 1064.

The network communication link may be one example of communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media,” as used herein, may include both storage media and communication media.

Computing device 1000 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. Computing device 1000 may also be implemented as a personal computer including both laptop computer and non-laptop computer configurations.

The present invention may be carried out in other specific ways than those herein set forth without departing from the scope of the invention. The present embodiments are, therefore, to be considered in all respects as illustrative and not restrictive, and all changes coming within the meaning and equivalency range of the appended claims are intended to be embraced therein.

What is claimed is:

1. An enterprise media content system comprising:
a data storage device configured to store an enterprise media content transcoded into a bundle of renditions;
a network component configured to receive a content request for the enterprise media content from a device and to communicate a most appropriate rendition of the enterprise media content to the device, the most appropriate rendition being selected from the bundle of renditions; and
a video control center configured to determine the most appropriate rendition based on real-time circumstances at the time of the content request.

2. The enterprise media content system of claim 1, wherein:
the video control center includes an enterprise media content platform configured to enable definition of one or more audiences; and
the real-time circumstances indicate the one or more audiences in which the device is included.

3. The enterprise media content system of claim 2, wherein:
the enterprise media content platform further includes a network location user interface configured to enable definition of one or more network locations;
the enterprise media content platform further includes a group/client device user interface configured to enable definition of one or more device groups; and
the enterprise media content platform is further configured to enable definition of one or more audiences based at least partially on the one or more network locations detected at the time of the content request and/or one or more device groups detected at the time of the content request.

4. The enterprise media content system of claim 3, wherein:
the one or more device groups may be defined according to one or more of a device type, a location of a device, a device characteristic, and a user associated with a device; and
the real-time circumstances include one or more of the device type, the location of a device, the device characteristic, and the user associated with a device.

5. A method of communicating enterprise media content, the method comprising:
receiving a content request for an enterprise media content from a device;
based on a real-time circumstance, determining an audience in which the device is included;
selecting a rendition of the enterprise media content from a bundle of renditions, the rendition being the most appropriate rendition for the audience; and
communicating the rendition to the device.

6. The method of claim 5, further comprising:
determining a bitrate cap at which the rendition is communicated to the device at the time the content request is received; and
capping the bitrate at which the rendition is communicated to the device according to the bitrate cap.

7. The method of claim 6, wherein capping the bitrate includes providing a substantially even distribution of bandwidth between the device and a second device to which another rendition is being communicated.

8. The method of claim 5, wherein:
the audience is defined to include one or more device groups; and
determining the audience includes detecting a device group in which the device is included at the time the content request is received.

9. The method of claim 8, wherein:
the device groups are defined according to one or more of a device type, a location of a device, a device characteristic, and a user associated with a device; and
determining an audience includes detecting the device type, the location of the device, the device characteristic, and the user associated with a device at the time the content request is received.

10. The method of claim 8, wherein:
the audience is defined to include one or more network locations; and
determining the audience includes detecting a network location in which the device is included at the time the content request is received.

11. The method of claim 10, wherein:
the network locations are defined according to a physical location and/or a type of communication; and
determining the audience includes detecting the physical location of the device and/or the type of communication used to communicate the content request.

12. The method of claim 10, further comprising:
determining a first bitrate cap for the network location;
determining a second bitrate cap for the device group;
determining a third bitrate cap for the audience; and
communicating the rendition to the device at a lowest of the first bitrate cap, the second bitrate cap, and the third bitrate cap.

13. The method of claim 5, wherein the device is associated with a user, the method further comprising:
receiving device identification information or a credential assigned to the user; and
based on the credential or the device identification information, selecting a rendition of the enterprise media content from the bundle of renditions, the rendition being the most appropriate rendition for the user.

14. A system comprising:
a processor; and
a tangible computer-readable storage medium communicatively coupled to the processor and having computer-executable instructions stored thereon that are executable by the processor to perform the method of claim 5.

15. A method of managing enterprise media content comprising:
transcoding an enterprise media content according to a profile to create a bundle of renditions;
defining device groups using a first set of configurable rules, the device groups including one or more devices or one or more users;
defining network locations using a second set of configurable rules, the network locations including a physical location or a type of communication; and
defining audiences to include at least one of the device groups and one of the network locations, the audiences being a basis on which a most appropriate rendition of the enterprise media content is selected for communication to a device.

16. The method of claim 15, further comprising capping a bitrate at which the most appropriate rendition is communicated to the audiences.

17. The method of claim 16, further comprising:
capping a bitrate at which the rendition is communicated to one or more of the device groups; and
capping a bitrate at which the rendition is communicated to one or more of the network locations.

18. The method of claim 15, wherein the device groups are defined according to one or more of a device type, a location of a device, a device characteristic, and a user associated with a device.

19. The method of claim 15, further comprising mapping a delivery system to one or more of the audiences through which the most appropriate rendition is communicated to a device.

20. The method of claim 15, further comprising:
defining a target audience; and
pushing a rendition of the bundle of renditions to the target audience.
